(19) United States
(12) Patent Application Publication
(10) Pub. No.: US 2025/0096355 A1
(43) Pub. Date: Mar. 20, 2025

(54) COOLING PLATE

(71) Applicant: MAHLE International GmbH, Stuttgart (DE)

(72) Inventors: Simon Hund, Stuttgart (DE); Jonathan Babitsch, Egenhausen (DE)

(21) Appl. No.: 18/890,736

(22) Filed: Sep. 19, 2024

(30) Foreign Application Priority Data
Sep. 20, 2023 (DE) 10 2023 209 117.8

(51) Int. Cl. H01M 10/6556; H01M 10/613; H01M 10/625

(52) U.S. Cl. CPC H01M 10/6556; H01M 10/613; H01M 10/625

(57) ABSTRACT

A cooling plate for a cooling device is disclosed. The cooling plate includes a first plate and a second plate connected tightly thereto, and cooling channels defined between the first plate and the second plate. A first recess is provided in the first plate and a second recess in the second plate, which are arranged substantially aligned with one another when the cooling plate is mounted. A cover element is provided, which is releasably connected to the first plate and covers the first recess, or which is releasably connected to the second plate and covers the second recess.

### CROSS-REFERENCE TO RELATED APPLICATION

This application claims priority to German Application No. DE 10 2023 209 117.8 filed Sep. 20, 2023, the contents of which are hereby incorporated by reference in its entirety.

### TECHNICAL FIELD

The present invention relates to a cooling plate for a cooling device, in particular for cooling a battery. The invention further relates to an electric or hybrid vehicle having a component, a battery, and a cooling device having at least such a cooling plate for tempering the battery.

### BACKGROUND

Due to environmental aspects, electric or hybrid vehicles are increasingly becoming the focus of consumers and are therefore increasingly being used on the roads. In order to be able to increase a range and also a performance of such electric or hybrid vehicles, it is desirable to keep a traction battery of such an electric or hybrid vehicle in a temperature window that is optimal for this traction battery, for which tempering devices, for example cooling devices, are used in a known manner.

Common tempering devices/cooling devices have cooling plates that are arranged below, above, or below and above the battery cells to be tempered. The so-called intercellular cooling is also known, in which the temperature control does not take place above or below, but laterally on the battery cell.

Cooling plates can also be placed in the vehicle floor and assume additional functions there, such as an underbody protection against, among other things, stone chipping, which is why such cooling plates are sometimes designed to be larger than is actually necessary for cooling, which means that access to other components is no longer possible or only possible to a limited extent.

Regardless of whether the cooling plate is used as a base or as a lid, the entire area below or above the cooling plate (in the battery housing) must be protected to prevent dirt and moisture from entering. For cooling plates below the battery cells (floor cooling), access to other components is not possible or only to a limited extent. Thus, if one of these components fails, the entire cooling plate would have to be dismantled. Since these are often joined together with the battery cells (e.g., glued together with a gap filler), this is extremely time-consuming and expensive.

Also with cooling plates above the battery cells (lid cooling), access to other components is not possible or only to a limited extent.

In addition, components with a high maintenance effort or a high probability of failure are often installed directly next to the battery cells due to their function, which then leads to considerable problems in the event of maintenance, since accessibility is significantly more difficult.

The present invention is therefore concerned with the problem of specifying a cooling plate, which in particular allows simplified maintenance of components arranged underneath.

According to the invention, this problem is solved by the subject matter of independent claim(s). Advantageous embodiments are the subject of the dependent claims.

### SUMMARY

The present invention is based on the general idea of designing a cooling plate for a traction battery of an electric or hybrid vehicle, for example, which in particular covers additional tasks, like stone chip protection, for example, in such a way that it allows easier access to components arranged in the area of the battery and in particular maintenance-intensive or components to be replaced at regular intervals, in particular without the entire cooling plate of a cooling device having to be removed from the battery or its battery cells. In order to be able to optimally use a battery, in particular a traction battery of an electric or hybrid vehicle, with regard to its performance, it is necessary to operate it in an optimum temperature window, for which a cooling device is usually provided. The term “cooling device” should of course be understood in the entire application to mean a temperature-control device, so that the cooling device is not only able to cool the traction battery or its battery cells, but also to heat them, if necessary, provided that, for example, an external temperature is below the temperature window optimal for the battery cells. This naturally also applies analogously to the cooling plate described in the present application, which is generally designed as a tempering plate and thus can also be used to heat the battery cells with the cooling plate by flowing through warm temperature-control fluid. The cooling plate according to the invention comprises a first plate and a second plate connected tightly thereto, which between themselves define cooling channels. The first plate is provided with embossed cooling channels, for example, while the second plate can be configured as a flat cover plate, for example, whereby a cooling channel structure predetermined by the embossing can be achieved between the first and second plate. In addition, the cooling plate according to the invention has a first recess in its first plate and a second recess in its second plate, which are arranged substantially aligned to one another when the position is in particular mounted on the battery/traction battery and thus allowing the reaching through the cooling plate at this point. The cooling plate designed in this way and arranged on the battery thus allows access to components arranged below the cooling plate, for example in the area of the recess. According to the invention, the cooling plate now comprises a cover element, which is releasably connected to the first plate and covers its first recess or which is releasably connected to the second plate and covers its second recess, depending on which of the two plates is turned away from the battery. The first and/or second recess can thus be covered and in particular tightly closed via the cover element, so that, for example, a cooling plate arranged in a floor area of an electric or hybrid vehicle is able to reliably protect the traction battery or other components from moisture and dirt. Due to the releasability of the cover element from the first plate or the second plate, it is comparatively easily possible, in a maintenance or repair case, to allow access to components arranged, for example, below the first and second recess, without first having to remove the entire cooling plate. This is particularly advantageous because the cooling plate is often glued with a heat conduction adhesive (gap filler) to the battery to be tempered or the battery cells to be tempered, which would make removal of the entire cooling plate extremely difficult and expensive by loosening and re-attaching the heat conduction adhesive. However, the releasable cover element makes it possible to create a maintenance opening, which becomes accessible comparatively easily, namely, for example, by unscrewing the cover element. The cover element is connected to the first plate or the second plate in such a way that a non-destructive disassembly is possible and that, in the assembled state, it closes the first or second recess tightly against media, in particular dirt and splash water.

In a further advantageous embodiment of the cooling plate according to the invention, the first plate and the second plate are glued, welded, screwed, or brazed together. It is also conceivable using a rolling bonding process, in which two plates/sheets are joined together by rolling at high pressure. During rolling bonding, individual areas of the plates can be spared or treated with release agents, so that they cannot connect there.

A screw connection with an interposition of a corresponding seal enables, for example, the opening or loosening of the first and second plates from one another, which in particular also facilitates a repair case in which only a second plate close to the floor is damaged, for example, so that it can be easily replaced. Usually, the two plates are connected tightly by means of a solder connection in a soldering furnace, whereby not only a simple and reliable connection can be created from a manufacturing point of view, but also an automated connection. Adhesive bonding is theoretically conceivable, which also allows automated and thus high-quality production at the same time.

In a further advantageous embodiment of the cooling plate according to the invention, the first plate and/or the second plate are formed from sheet metal, in particular from aluminum sheet metal. Aluminum has the great advantage of being light on the one hand and having a high thermal conductivity on the other hand, which in particular enables a high heat transfer to the battery to be tempered. Purely theoretically, it is of course also conceivable that the first plate is made of sheet metal, in particular aluminum sheet metal, and the second plate is made of plastic, wherein the second plate is then used, for example, as a base plate for an underbody assembly of the cooling plate according to the invention. This offers the great advantage that it promotes a heat transfer from the cooling plate via the first plate formed from sheet metal, in particular from aluminum sheet, to the battery/traction battery to be tempered; on the other hand, a heat transfer via the second plate formed from plastic into the environment is made more difficult.

In another advantageous embodiment, the cover element is formed from sheet metal, in particular aluminum sheet metal. An embodiment of the cover element made of sheet metal, in particular made of the same metallic material as the first or second plate on which the cover element is arranged, offers the great advantage that there is no potential difference between the cover element and the associated plate that can lead to contact corrosion in the long term.

Alternatively, it is of course also conceivable that the cover element is made of plastic, in particular as a plastic injection molded part, which not only allows a cost-effective but also a high-quality production of the cover element.

The cover element is appropriately connected tightly to the first plate or the second plate. A tight connection can be made, for example, by a screw connection with the interposition of a corresponding seal, wherein such a screw connection also makes a disassembly of the cover element during maintenance comparatively simple, namely by loosening the screws. Alternatively, clipping or detachable gluing of the cover element to the first plate or the second plate is also conceivable, wherein it should be ensured in all connection methods that the connection is designed to be tight, in particular fluid-tight, in order to protect both the battery/traction battery arranged behind the cooling plate and components disposed behind the cooling plate from dirt and moisture. Even when it is glued, it is designed so that it can be detached and easily reattached.

In a particularly preferred embodiment of the cooling plate, the cover element has stiffening structures. Such stiffening structures can be produced, for example, by embossed grooves, notches, etc., in particular if the cover element is formed as a sheet metal part, for example. In this case, the stiffening structures can be embossed comparatively easily.

The present invention is further based on the general idea of specifying an electric or hybrid vehicle having a component, a battery, in particular a traction battery, as well as a cooling device having at least one cooling plate for tempering, in particular for cooling, the battery described in the previous paragraphs. The cooling plate is connected to the battery in a heat-transmitting manner, for example glued, wherein the cover element is arranged on the cooling plate in such a way that it allows access to the component after removal. The component can, for example, be a component with a high probability of failure or a high maintenance effort, which must in particular be accessible not only in the event of maintenance, but also at regular intervals. The use of the cooling plate according to the invention in the electric or hybrid vehicle according to the invention significantly simplifies maintenance or repair of the same, because only the cover element has to be removed from the first or second plate in order to access the component to be serviced or repaired, but the cooling plate itself can remain on the battery, in particular on the traction battery. Compared to previous solutions, in which the entire cooling plate had to be removed and then re-glued to the battery, this represents a considerable relief, which is also reflected in significantly reduced maintenance or repair costs.

The first recess and the second recess are expediently disposed in an area that requires reduced cooling of the battery and/or the component or only reduced or no cooling or temperature control is required. This offers the great advantage that even in the normal state of use, in which the cover element is tightly connected to the first or second plate, the recesses underneath have no negative influence on the cooling effect of the cooling plate. The first and second recess can, for example, be located in an area away from the battery or the component, which is covered by the cooling plate only for underbody protection. The arrangement of the two recesses in this area thus has no effect on the cooling effect of the cooling plate, but facilitates access to the component considerably in the event of maintenance.

Further important features and advantages of the invention are apparent from the subclaims, from the drawings, and from the associated description of the figures with reference to the drawings.

It is understood that the above-mentioned features and those yet to be explained below can be used not only in the combination indicated in each case, but also in other combinations or on their own, without deviating from the scope of the present invention. The above-mentioned components of a superordinate unit, such as a device, an apparatus, or an arrangement, which are designated separately, can form separate parts or components of this unit or be integral areas or sections of this unit, even if this is shown differently in the drawings.

Preferred exemplary embodiments of the invention are shown in the drawings by way of example and will be explained in more detail in the following description, wherein identical reference signs refer to identical or similar or functionally identical elements.

### BRIEF DESCRIPTION OF THE DRAWINGS

These show, schematically in each case, in

FIG. 1 a cooling plate according to the invention in an exploded view,

FIG. 2 a mounted cooling plate with the cover element removed,

FIG. 3 an illustration as in FIG. 2, but with a tightly attached cover element,

FIG. 4 a possible installation situation of the cooling plate according to the invention in an electric or hybrid vehicle according to the invention.

### DETAILED DESCRIPTION

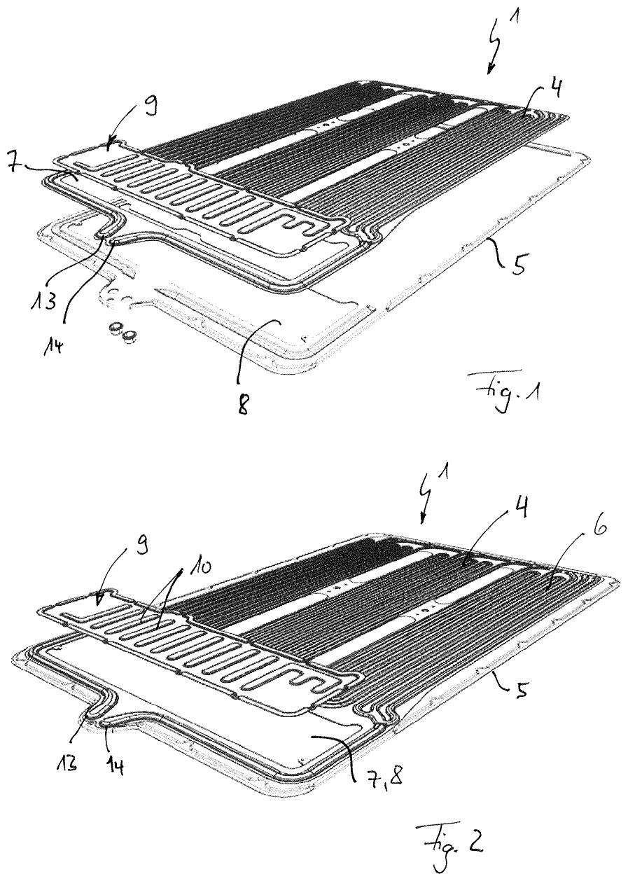

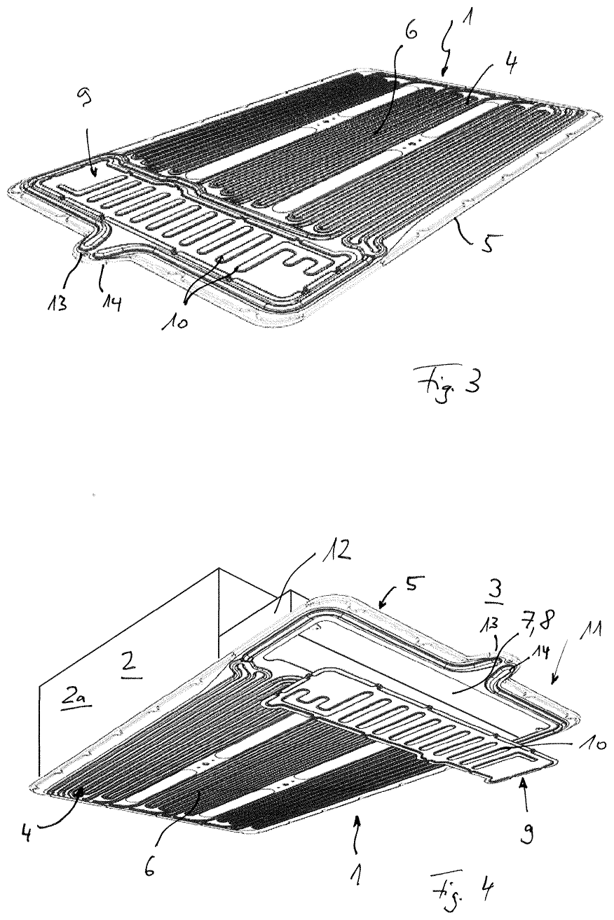

According to FIGS. 1 to 4, a cooling plate 1 according to the invention, in particular for cooling a battery 2, for example a traction battery 2a, in particular in an electric or hybrid vehicle 3, comprises a first plate 4 and a tightly connected second plate 5, which delimit between cooling channels 6. In the present case, for example, the first plate 4 is designed as an embossed plate and has the cooling channels 6 as depressions, while the second plate 5 is designed as a flat cover plate, which merely covers the cooling channels 6. A flat adhesion to the battery 2 can occur via the second and flat plate 5. A first recess 7 is arranged in the first plate 4, while a second recess 8 is arranged in the second plate 5, wherein the two recesses 7, 8 are arranged essentially aligned to one another when the cooling plate 1 is mounted, thereby allowing the cooling plate 1 to be engaged or access at this point. A cover element 9 is further provided, which is releasably connected to the first plate 4, in particular to an edge of the first recess 7, and covers the first recess 7 or which is releasably connected to the second plate 5 and covers its second recess 8. In the cases shown according to FIGS. 1 to 4, the cover element 9 is releasably tight and firmly connected/connectable to the first plate 4.

In the entire description of the figure, only a cooling plate 1 is mentioned, which of course can be used not only for cooling, but also for heating and thus generally for temperature control, for example for the battery 2.

The two plates 4, 5 are tightly connected to one another, for example glued, welded, soldered, or screwed together. It is also conceivable via a roll bonding process in which the two plates 4, 5 are joined together by rolling at high pressure. During rolling bonding, individual areas of the plates 4, 5 can be spared or treated with release agents, so that they cannot connect there.

The first plate 4 and/or the second plate 5 can be made of sheet metal, in particular aluminum sheet metal, as a result of which a high heat transfer for cooling the battery 2 is made possible. Purely theoretically, it is of course also conceivable that the first plate 4 or the second plate 5 is made of plastic, in particular as a plastic injection molded part, as a result of which the cooling plate 1 on its outside facing away from the battery 2 to be tempered allows only reduced heat transfer, whereby a better temperature control of the battery 2, in particular a better cooling of the latter, is possible.

The cover element 9 can in turn be made of plastic or likewise of a sheet metal, which, for example, is made of an aluminum sheet, wherein, in one embodiment made of metal and one embodiment of the first plate 4 or the second plate 5, to which the cover element 9 is connected, also made of metal, it is advantageous, both the cover element 9 and the associated plate 4, 5 from the same material, to avoid contact corrosion due to a potential difference. A sealing element that is not shown can of course still be provided between the cover element 9 and the associated plate 4, 5 in order to be able to reliably seal the first recess 7 or the second recess 8 against dirt and moisture.

If one continues to consider the cover element 9, it can be seen that it has stiffening structures 10, for example ribs, which give the cover element 9 a higher stiffness. Such stiffening structures 10 can, for example, be produced in a plastic injection molding process and/or, in the case of a sheet metal formation, be embossed in a forming process by means of a forming tool.

A connection of the cover element 9 to the associated first plate 4 or the second plate 5 occurs here, for example, by screwing or clipping or gluing, but in all cases via a detachable and at the same time tight connection. In particular a screwing of the cover element 9 with the first plate 4 or generally with the associated plate 4, 5 enables a comparatively simple and non-destructive removal of the same in the event of maintenance and repair, wherein the cover element 9 can be tightly reconnected via the associated plate 4, 5 and the cover element 9, for example by means of a seal injection molded onto the cover element 9 by means of a simple screwing on with the associated plate 4, 5.

If one considers FIG. 4, one can see there an electric or hybrid vehicle 3 according to the invention, which has a battery 2, for example a traction battery 2a, for driving the electric or hybrid vehicle 3, in particular in a floor area. The battery 2 is cooled by means of a cooling device 11, to which the cooling plate 1 also belongs. The cooling plate 1 lies against the battery 2 to be cooled or tempered in a heat-transmitting manner and is connected to it, for example, via a heat-conducting adhesive. Furthermore, the electric or hybrid vehicle 3 has a component 12, which is not, or at least not to the extent, that the battery 2 must be cooled. The component 12 can, for example, be a component with a high maintenance effort or high probability of failure and must therefore be easily accessible to maintain the function of the electric or hybrid vehicle 3 in the long term. In this case, the invention relates to the cooling plate 1 according to the invention, the recesses 7, 8 of which are arranged in such a way that problem-free access to the component 12 is made possible when the cover element 9 is removed. Until now, the entire cooling plate 1 had to be removed for this purpose, which has caused the heat-conducting adhesive connection between the cooling plate 1 and the battery 2 to be destroyed, as well as a complex reattachment of the adhesive connection. Due to the cover element 9 provided according to the invention, which tightly covers the recesses 7, 8 in the assembled state, the accessibility, in particular for maintenance and repair purposes, can be significantly simplified, which significantly reduces the maintenance and repair costs. The recesses 7, 8 can be arranged in an area of the battery 2 or the component 12, which on the one hand requires only a reduced temperature control effort, in particular a cooling effort, and on the other hand must be easily accessible to reduce the maintenance and repair effort.

In the embodiments of the cooling plate 1 according to the invention shown in FIGS. 1 to 4, the recesses 7, 8 each have a substantially rectangular cross-section, wherein an inlet 13 and an outlet 14 to or from the cooling channels 6 run along the edge of the recess 7, 8.

With the cooling plate 1 according to the invention and the electric or hybrid vehicle 3 according to the invention, a maintenance and repair effort can be significantly reduced, since only the cover element 9 is removed for access to a component 12 to be serviced or repaired and after maintenance or repair, but the remaining cooling plate 1 can remain on the electric or hybrid vehicle 3. This offers the great advantage that an adhesive layer existing between the cooling plate 1 and a battery 2 to be cooled, for example, from the cooling plate 1, does not have to be destroyed and then reapplied. The cooling plate 1 also does not have to be separated from the cooling device 11 of the electric or hybrid vehicle 3 with respect to its fluid connections, which represents a further considerable relief.

1. A cooling plate for a cooling device, comprising:
a first plate and a second plate connected tightly thereto, and cooling channels defined between the first plate and the second plate,
a first recess in the first plate and a second recess in the second plate, the first recess and the second recess arranged substantially aligned with one another when the cooling plate is mounted and allow the cooling plate to engage through at this point,
a cover element, which is releasably connected to the first plate and covers the first recess, or which is releasably connected to the second plate and covers the second recess.

2. The cooling plate according to claim 1, wherein the first plate and the second plate are glued, welded, screwed, soldered, or connected to one another via a roll bonding technique.

3. The cooling plate according to claim 1, wherein the first plate and/or the second plate are made composed of sheet metal.

4. The cooling plate according to claim 1, wherein the first plate and/or the second plate are composed of plastic.

5. The cooling plate according to claim 1, wherein the cover element is composed of sheet metal or plastic.

6. The cooling plate according to claim 1, wherein the cover element is tightly connected to the first plate or the second plate.

7. The cooling plate according to claim 1, wherein the cover element comprises stiffening structures.

8. The cooling plate according to claim 1, wherein the cover element is releasably glued, screwed, or clipped to the first plate or the second plate.

9. An electric or hybrid vehicle, comprising:
a component,
a battery,
a cooling device having at least one cooling plate for cooling the battery, the at least one cooling plate including:
a first plate and a second plate connected thereto, with cooling channels defined between the first plate and the second plate,
a first recess in the first plate and a second recess in the second plate, the first recess and the second recess arranged substantially aligned with one another when the at least one cooling plate is mounted and allow the at least one cooling plate to engage through at this point,
a cover, which is releasably connected to the first plate and covers the first recess, or which is releasably connected to the second plate and covers the second recess,
wherein the at least one cooling plate is connected to the battery in a heat-transmitting manner, and
wherein the cover element is arranged on the at least one cooling plate such that it allows access to the component and/or the battery after removal.

10. The electric or hybrid vehicle according to claim 9, wherein the first recess and the second recess are arranged in an area that only requires reduced cooling of the battery and/or the component.

11. The electric or hybrid vehicle according to claim 9, wherein the at least one cooling plate is glued to the battery.

12. The electric or hybrid vehicle according to claim 9, wherein the first plate and the second plate are glued, welded, screwed, soldered, or roll-bonded to one another.

13. The electric or hybrid vehicle according to claim 9, wherein the first plate and/or the second plate are composed of sheet metal.

14. The electric or hybrid vehicle according to claim 9, wherein the first plate and/or the second plate are composed of plastic.

15. The electric or hybrid vehicle according to claim 9, wherein the cover is composed of sheet metal.

16. The electric or hybrid vehicle according to claim 9, wherein the cover is composed of plastic.

17. The electric or hybrid vehicle according to claim 9, wherein the cover is tightly connected to the first plate or the second plate.

18. The electric or hybrid vehicle according to claim 9, wherein the cover comprises stiffening structures.

19. The electric or hybrid vehicle according to claim 9, wherein the cover is releasably glue, screwed, or clipped to the first plate.

20. The electric or hybrid vehicle according to claim 9, wherein the cover is releasably glue, screwed, or clipped to the second plate.
